(19) United States
(12) Patent Application Publication
(10) Pub. No.: US 2018/0038799 A1
(43) Pub. Date: Feb. 8, 2018

(54) RAMAN AND SURFACE ENHANCED RAMAN SPECTROSCOPY FOR MONITORED DRUGS

(71) Applicant: Northwestern University, Evanston, IL (US)

(72) Inventors: Richard P. Van Duyne, Wilmette, IL (US); Stephanie Zaleski, Chicago, IL (US)

(21) Appl. No.: 15/668,183

(22) Filed: Aug. 3, 2017

Related U.S. Application Data
(60) Provisional application No. 62/370,628, filed on Aug. 3, 2016.

(51) Int. Cl. G01N 21/65; G01N 27/30

(52) U.S. Cl. CPC G01N 21/65; G01N 27/301; C01B 33/12

(57) ABSTRACT

The present disclosure provides systems, methods, and kits for identifying and determining the concentration of a drug of interest suspected of being present in an intravenous drug solution. An electrochemical surface enhanced Raman (EC-SERS) substrate is used to acquire an EC-SERS spectrum of the intravenous drug solution. The EC-SERS spectrum is used to identify whether the drug of interest is present in the intravenous drug solution and, if it is present, what the concentration of the drug of interest is in the intravenous drug solution. This identification and concentration determination can be used at the point of delivery to authenticate intravenous drugs.

### CROSS-REFERENCE TO RELATED APPLICATIONS

This application is related to, claims priority to, and incorporates by reference herein for all purposes U.S. Provisional Patent Application 62/370,628, filed Aug. 3, 2016.

### STATEMENT REGARDING FEDERALLY FUNDED RESEARCH

N/A

### BACKGROUND

There is a critical need to accurately monitor drugs to prevent adverse drug events (ADEs), which include errors such as incorrect drug type prescribed for the patient or drug mislabeling, incorrect concentration, and simultaneous delivery of incompatible drugs. The number of reported ADEs in infusion pumps totaled 56 000 in a 4 year period, 710 of which led to death. The primary means of administering drugs in infusion pump lines is preprogrammed drug libraries that specify dose limits of particular medications. Although this method is useful for controlling infusion rates, it does not have the ability to accurately identify and quantify the medication administered or to determine whether it is correct. While it is possible to identify and quantify administered drugs using reporter systems such as functionalized nanoparticles, reporter systems cannot be introduced into a patient's intravenous (IV) line due to safety concerns. Therefore, highly sensitive, noninvasive techniques are required to accurately monitor administered IV therapy drugs. There is also a need to accurately and rapidly identify the concentrations of compounded solutions or solutions in which a drug composition is specifically altered for the needs of an individual patient; errors in drug compounding of a steroid drug led to a major meningitis outbreak in 2012. Recent efforts to sensitively monitor therapeutic drugs involve the development of nanoscale biosensors, which relate to the careful monitoring of an administered drug over time or identifying drug-induced physiological changes that occur.

Nanoscale biosensors are advantageous over well-established biosensing techniques because they typically require minimal sample preparation, are relatively low cost, and often provide a higher level of detection sensitivity. For example, optical nanoscale biosensors based on detection via fluorescence spectroscopy and surface plasmon resonance (SPR) spectroscopy are attractive candidates for therapeutic drug monitoring. The aforementioned techniques typically rely on monitoring a change in optical response upon the drug of interest binding to the optically active surface. Despite the sensitivity of fluorescence and SPR, these techniques are not label-free, typically requiring an indirect reporter molecule or binding event to occur in order to sense the target analyte.

### SUMMARY

The present disclosure overcomes the aforementioned drawbacks by presenting methods and systems relating to monitoring drug identity and concentration.

In an aspect, the present disclosure provides a system for identifying and measuring concentration of a drug of interest in an intravenous drug solution. The system includes a sample chamber, an electrochemical surface enhanced Raman (EC-SERS) substrate, a counter electrode, a power supply, a Raman spectrometer, and a computer. The sample chamber is configured to receive the intravenous drug solution. The EC-SERS substrate is positioned in the sample chamber in a first location where the intravenous drug solution contacts the EC-SERS substrate when introduced into the sample chamber. The counter electrode is positioned in the sample chamber in a second location where the intravenous drug solution contacts the counter electrode when introduced into the sample chamber and is separated from the EC-SERS substrate by a first predetermined distance. The power supply is coupled to the EC-SERS substrate and the counter electrode. The computer includes a processor and a memory. The processor is in electronic communication with the power supply and the Raman spectrometer. The memory has stored thereon a reference spectrum for the drug of interest in the intravenous drug solution. The power supply is configured to apply a voltage to the EC-SERS substrate. The Raman spectrometer is configured relative to the EC-SERS substrate to acquire a Raman spectrum of the intravenous drug solution when the intravenous drug solution is contacting the EC-SERS substrate. The memory further has stored thereon instructions that, when executed by the processor, cause the processor to control the power supply and Raman spectrometer to acquire an EC-SERS spectrum of the intravenous drug solution in the sample chamber.

In another aspect, the present disclosure provides a method including: acquiring an electrochemical surface enhanced Raman (EC-SERS) spectrum of an intravenous drug solution, the intravenous drug solution suspected of containing a drug of interest in a desired concentration, the acquired EC-SERS spectrum having peak locations and peak intensities; comparing the acquired EC-SERS spectrum to a reference EC-SERS spectrum for the drug of interest in the desired concentration, the reference EC-SERS spectrum having reference peak locations and reference peak intensities; if the peak locations match the reference peak locations within a first predefined error value, then confirming that the intravenous drug solution contains the drug of interest; and if the peak intensities match the reference peak intensities within a second predefined error value, then confirming that the intravenous drug solution contains the drug of interest in the desired concentration.

In a further aspect, the present disclosure provides a kit. The kit includes an electrochemical surface enhanced Raman (EC-SERS) chip comprising an EC-SERS substrate and a counter electrode separated by a first predetermined distance; and a memory having stored thereon a reference EC-SERS spectrum for identifying and determining a concentration of a drug of interest in an intravenous drug solution by acquiring an EC-SERS spectrum of the intravenous drug solution using the EC-SERS chip.

### BRIEF DESCRIPTIONS OF THE DRAWINGS

FIG. 1 is a schematic of a system, in accordance with an aspect of the present disclosure.

FIG. 2A is an image of an EC-SERS chip, in accordance with an aspect of the present disclosure.

FIG. 2B is an image of an EC-SERS chip, in accordance with an aspect of the present disclosure.

FIG. 2C is an image of an EC-SERS chip deployed in a sample chamber that is filled with an intravenous drug solution, in accordance with an aspect of the present disclosure.

FIG. 3 is a plot of normal Raman spectra of gentamicin solutions in MQ H₂O at various concentrations compared to the pure gentamicin solid. Acquisition parameters: λₑₓ=785 nm, Pₑₓ=50 mW, and t_{acq}=5 s.

FIG. 4 is a cyclic voltammogram of 12 mM dobutamine in 0.5% sodium bisulfite at pH=3.5. Au disc working electrode, Pt wire counter electrode, and Ag/AgCl reference electrode.

FIG. 5 is a schematic of 2-electron, 2-proton transfer of dobutamine from its catechol to quinone species.

FIG. 6A is a representative SEM image of 540 nm SiO₂ spheres dropcasted on a cleaned Si wafer with 150 nm Au thermally deposited on top of the spheres.

FIG. 6B is an LSPR of AuFON in air (black trace) and in 4 mg/mL aqueous dobutamine solution (gray trace). The gray bar represents the wavelength region of Raman scattered light of interest in this work.

FIG. 7 is a representative 12 mM (4 mg/mL) dobutamine EC-SERS spectrum at −0.4 V (black trace) compared to NRS of 0.1 M solid dobutamine in MeOH (gray trace). MeOH peaks are starred. SERS data: λₑₓ=785 nm, Pₑₓ=980 μW, and t_{acq}=30 s. NRS data: λₑₓ=785 nm, Pₑₓ=3.4 mW, and t_{acq}=120 s. Both data sets were acquired using a 20× microscope objective.

FIG. 8 is a dobutamine EC-SERS 1605 cm⁻¹ mode integrated peak intensity as a function of applied potential.

FIG. 9 is an accuracy measurement of 6 mM (2 mg/mL) dobutamine solution with water washing steps in between each aliquot. Each aliquot is measured on the same AuFON substrate. SERS spectra acquisition parameters: λₑₓ=785 nm, Pₑₓ=980 μW, and t_{acq}=30 s.

FIG. 10 is a limit of detection determination for dobutamine. Each data point is an average of 5 spectra acquired from different spots on the AuFON surface. SERS spectra acquisition parameters: λₑₓ=785 nm, Pₑₓ=980 μW, and t_{acq}=30 s.

FIG. 11 is an EC-SERS of 12 mM (4 mg/mL) dobutamine on an AuFON chip device taken with a CBEx hand-held Raman spectrometer. Acquisition parameters: λₑₓ=785 nm, Pₑₓ=50 mW, and t_{acq}=1 s.

### DETAILED DESCRIPTION

Before the present invention is described in further detail, it is to be understood that the invention is not limited to the particular embodiments described. It is also understood that the terminology used herein is for the purpose of describing particular embodiments only, and is not intended to be limiting. The scope of the present invention will be limited only by the claims. As used herein, the singular forms “a”, “an”, and “the” include plural embodiments unless the context clearly dictates otherwise.

Specific structures, devices and methods relating to modifying biological molecules are disclosed. It should be apparent to those skilled in the art that many additional modifications beside those already described are possible without departing from the inventive concepts. In interpreting this disclosure, all terms should be interpreted in the broadest possible manner consistent with the context. Variations of the term “comprising” should be interpreted as referring to elements, components, or steps in a non-exclusive manner, so the referenced elements, components, or steps may be combined with other elements, components, or steps that are not expressly referenced. Embodiments referenced as “comprising” certain elements are also contemplated as “consisting essentially of” and “consisting of” those elements. When two or more ranges for a particular value are recited, this disclosure contemplates all combinations of the upper and lower bounds of those ranges that are not explicitly recited. For example, recitation of a value of between 1 and 10 or between 2 and 9 also contemplates a value of between 1 and 9 or between 2 and 10.

The various aspects may be described herein in terms of various functional components and processing steps. It should be appreciated that such components and steps may be realized by any number of hardware components configured to perform the specified functions.

### Systems

This disclosure provides systems. The systems can be suitable for use with the methods described herein. When a feature of the present disclosure is described with respect to a given system, that feature is also expressly contemplated as being combinable with the other systems, the methods, and the kits described herein, unless the context clearly dictates otherwise.

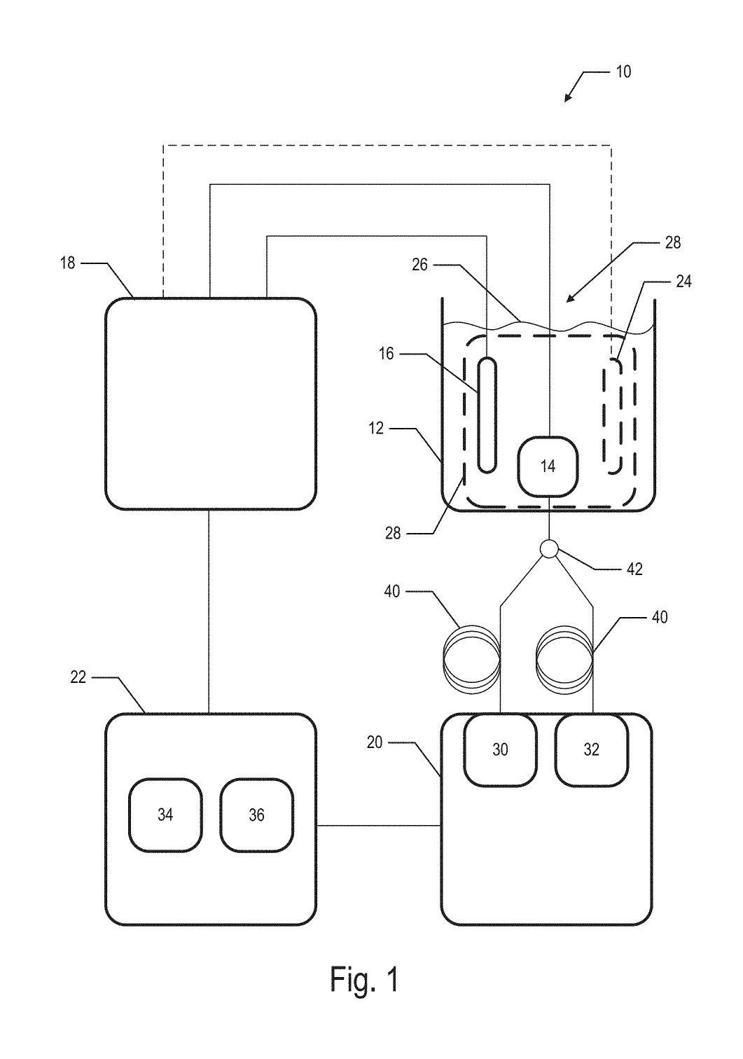

Referring to FIG. 1, in an aspect, the present disclosure provides a system 10 for identifying and measuring concentration of a drug in an intravenous drug solution. The system 10 includes a sample chamber 12, an electrochemical surface enhanced Raman (EC-SERS) substrate 14, a counter electrode 16, a power supply 18, a Raman spectrometer 20, and a computer 22. The system 10 can also include a reference electrode 24.

The sample chamber 10 can be configured to receive an intravenous drug solution 26. The sample chamber 10 can include an inlet 28. The inlet 28 can be configured in a variety of ways, including but not limited to, as an opening in the top of the sample chamber 10, such as an opening of a beaker or an opening of a sample well, a threaded opening or puncturable opening, such as those known in the medical arts to be suitable for coupling to an intravenous bag via tubing of an intravenous drug delivery system, and the like.

The EC-SERS substrate 14 can be a substrate suitable for acquiring an EC-SERS spectrum, as would be understood to those having ordinary skill in the art. The EC-SERS substrate 14 can in some cases be a film over nanosphere (FON) substrate, where a plurality of nanospheres or microspheres are distributed on a substrate and coated with a film. The FON substrate can in some cases comprise SiO₂ microspheres coated with a gold layer. The EC-SERS substrate 14 is positioned at a first location within the sample chamber 12 in a fashion such that introduction of the intravenous drug solution 26 into the sample chamber 12 initiates contact between the intravenous drug solution 26 and the EC-SERS substrate 14. In some cases, this can involve positioning the EC-SERS substrate 14 on the bottom of the sample chamber 12.

The counter electrode 16 can be composed of a material that would be understood to those having ordinary skill in the electrochemical arts to be suitable for serving as a counter electrode material. In some cases, the counter electrode 16 can be a Pt counter electrode. The counter electrode 16 can be positioned in the sample chamber in a second location in the sample chamber 12 in a fashion such that introduction of the intravenous drug solution 26 into the sample chamber 12 initiates contact between the intravenous drug solution 26 and the counter electrode 16. The counter electrode 16 is separated from the EC-SERS substrate 14 by a first predetermined distance.

The reference electrode 24 can be composed of a material that would be understood to those having ordinary skill in the electrochemical arts to be suitable for serving as a reference electrode material. In some cases, the reference electrode 24 can be an Ag/AgCl reference electrode. The reference electrode 24 can be positioned in the sample chamber in a third location in the sample chamber 12 in a fashion such that introduction of the intravenous drug solution 26 into the sample chamber 12 initiates contact between the intravenous drug solution 26 and the reference electrode 24. The reference electrode 24 is separated from the EC-SERS substrate 14 by a second predetermined distance and from the counter electrode 16 by a third predetermined distance.

The EC-SERS substrate 14 and the counter electrode 16 can be positioned on a single EC-SERS chip 38. In some cases, the EC-SERS substrate 14, the counter electrode 16, and the reference electrode 24 can be positioned on a single EC-SERS chip 38.

The power supply 18 can be any power supply known to those having ordinary skill in the electrochemical arts to be suitable for applying voltages in the fashion necessary to achieve the experiments described herein. The power supply 18 can also include various electrical measurement capabilities, such as the ability to measure voltages across various electrodes. The power supply 18 is coupled to the EC-SERS substrate 14, the counter electrode 16, and the optional reference electrode 24 and configured to apply and/or measure relevant voltages across those electrodes.

The Raman spectrometer 20 includes a Raman light source 30 and a Raman light detector 32. Light from the Raman light source 30 can be coupled to the EC-SERS substrate 14 by various optics known to those having ordinary skill in the art. For example, in the illustrated aspect of FIG. 1, an optical waveguide 40 is used to couple light from the Raman light source 30 to the EC-SERS substrate 14. Similarly, various optics can be used to couple light from the EC-SERS substrate 14 to the Raman light detector 32. Other coupling optics 42, such as circulators, lenses, microscope objectives, and other optics suitable for coupling light to and retrieving light from the EC-SERS substrate 14. The Raman spectrometer 20 can be configured relative to the EC-SERS substrate 14 to acquire a Raman spectrum of the intravenous drug solution 26 when the intravenous drug solution 26 is contacting the EC-SERS substrate 14. In other words, the Raman spectrometer 20 optically coupled to the EC-SERS substrate 14 in a fashion understood by those having ordinary skill in the art of optics to be suitable for acquiring an EC-SERS spectrum. The Raman spectrometer 20 can be further configured to acquire normal Raman spectra. The Raman spectrometer 20 can be a handheld Raman spectrometer.

The computer 22 includes a processor 34 and a memory 36. The processor 34 can take any form known to those having ordinary skill in the computing arts to be suitable to execute the various functions described herein. The memory 36 can be any non-transitory computer readable medium known to those having ordinary skill in the computing arts.

The memory 36 can have one or more reference EC-SERS spectra or normal Raman spectra stored thereon for the purposes of comparison, as discussed below with respect to the various methods. These reference spectra are identified for the particular drug of interest and concentration of interest to which they are associated. These reference spectra include reference peak locations and reference amplitudes. A person having ordinary skill in the spectroscopic arts would understand how to acquire a reference spectrum for a given drug of interest and concentration of interest.

The memory 36 can also have stored thereon instructions that, when executed by the processor, cause the processor to control the power supply and Raman spectrometer to acquire an EC-SERS spectrum of the contents of the sample chamber 12, namely, the intravenous drug solution 26.

It should be appreciated that the computer 22 can be separate and distinct from the power supply 18 and/or the Raman spectrometer 20 or can be integrated with one or both. The processor 34 can be a single processor or can be multiple processors linked together for coordinated operation. The memory can similarly be a single memory or multiple memories that are capable of storing and retrieving information alone or in concert.

Information can be transmitted and received in wired or wireless interfaces known to those having ordinary skill in the signal transmission arts.

The present disclosure also provides a system for acquiring a normal Raman spectrum of an intravenous drug solution in order to determine identity and concentration of a drug suspected of being present in the intravenous drug solution. This system can include a handheld Raman spectrometer and a computer, such as the computer 22 described elsewhere herein.

### Methods

This disclosure also provides a variety of methods. It should be appreciated that various methods are suitable for use with the other methods described herein. Similarly, it should be appreciated that various methods are suitable for use with the systems and kits described elsewhere herein. When a feature of the present disclosure is described with respect to a given method, that feature is also expressly contemplated as being useful for the other methods and the systems described herein, unless the context clearly dictates otherwise.

The present disclosure provides a method of certifying that an intravenous drug solution contains a drug of interest in a desired concentration. The method includes: acquiring an electrochemical surface enhanced Raman (EC-SERS) spectrum of an intravenous drug solution, the intravenous drug solution suspected of containing a drug of interest in a desired concentration, the acquired EC-SERS spectrum having peak locations and peak intensities; comparing the acquired EC-SERS spectrum to a reference EC-SERS spectrum for the drug of interest in the desired concentration, the reference EC-SERS spectrum having reference peak locations and reference peak intensities; if the peak locations match the reference peak locations within a first predefined error value, then confirming that the intravenous drug solution contains the drug of interest; and if the peak intensities match the reference peak intensities within a second predefined error value, then confirming that the intravenous drug solution contains the drug of interest in the desired concentration.

The present disclosure also provides a method of certifying that an intravenous drug solution contains a drug of interest in a desired concentration. The method includes: acquiring a normal Raman spectrum of an intravenous drug solution using a handheld Raman spectrometer, the intravenous drug solution suspected of containing a drug of interest in a desired concentration, the acquired normal Raman spectrum having peak locations and peak intensities; comparing the acquired normal Raman spectrum to a reference normal Raman spectrum for the drug of interest in the desired concentration, the reference normal Raman spectrum having reference peak locations and reference peak intensities; if the peak locations match the reference peak locations within a first predefined error value, then confirming that the intravenous drug solution contains the drug; and if the peak intensities match the reference peak intensities within a second predefined error value, then confirming that the intravenous drug solution contains the drug of interest in the desired concentration.

### Kits

This disclosure also provides kits. It should be appreciated that various kits are suitable for use with the methods described herein. Similarly, it should be appreciated that various kits are suitable for use with the systems described elsewhere herein. When a feature of the present disclosure is described with respect to a given kit, that feature is also expressly contemplated as being useful for the other methods and the systems described herein, unless the context clearly dictates otherwise.

The kit can include an EC-SERS chip 28, such as the one described above, and a memory having stored thereon a reference EC-SERS spectrum for identifying and determining a concentration of a drug of interest in an intravenous drug solution by acquiring an EC-SERS spectrum of the intravenous drug solution using the EC-SERS chip.

### Example 1

Chemicals.

Hydrogen peroxide solution 30% (H₂O₂), ammonium hydroxide solution 28-30% (NH₄OH), sodium hydroxide (NaOH), 1 N hydrochloric acid (HCl), and gentamicin 50 mg/mL standard solution in deionized water were purchased from Sigma-Aldrich and used without further modification. Gentamicin in 0.9% sodium chloride IV bag solution (2 mg/mL) and dobutamine IV bag solutions in 5% dextrose and 1% sodium bisulfite (1, 2, and 4 mg/mL, pH=3.5) were received from Baxter; gentamicin dilutions were prepared in 0.9% sodium chloride, and dobutamine dilutions were prepared in Milli-Q (MQ) water. Milli-Q water with a resistivity higher than 18.2 MS2 cm was used in all preparations.

FON Fabrication.

Twenty-five mm diameter circular polished Si wafers were purchased from Wafernet, Inc. The Si wafers were first cleaned with Piranha solution for 30 min (3:1 H₂SO₄/H₂O₂), rinsed copiously with MQ H₂O, and then treated with 5:1:1 H₂O/H₂O₂/NH₄OH for 45 min to render the surface hydrophilic. The wafers were stored in MQ H₂O prior to use. 540 nm SiO₂ microspheres (Bangs Laboratories, Indiana) were diluted to 5% with MQ water, and 10-12 μL was dropcasted onto the Si wafer and allowed to dry. After drying, 150 nm Au was thermally deposited on the FON mask surface (PVD-75, Kurt J. Lesker).

Bulk Electrochemistry.

Bulk electrochemical measurements were performed in a capped scintillation vial. A polished Au disc electrode was utilized as the working electrode and was submerged in solution approximately 1 cm above the Pt wire counter electrode. The reference potential was determined by a leak-free Ag/AgCl reference electrode (Harvard Apparatus). Electrochemical measurements were performed using a CH Instruments potentiostat (CHI660D).

EC-SERS Sample Preparation.

AuFON working electrodes were prepared by first cutting the as-deposited FON into 1 cm² pieces with a diamond scribe pen. A 0.25 mm diameter Ag wire (Alfa Aesar) was then attached to the FON using conductive Ag epoxy (Ted Pella) to allow for electrical contact with the AuFON. A 2 mm diameter leak-free Ag/AgCl electrode (Harvard Apparatus) and a 1 cm length, 0.5 mm diameter Pt wire (Alfa Aesar) were utilized as the reference electrode and counter electrode, respectively. A #1.5 glass coverslip bottom well plate (Mattek Corporation) was used as the cell for EC-SERS measurements, using an experimental setup similar to that illustrated in FIG. 1. Approximately 1.5 mL of the solution of interest was pipetted into a well, and the electrodes were suspended in the solution of interest using a rubber septum. The potential was controlled using a CH Instruments potentiostat (CHI660D).

Instrumentation.

LSPR measurements were acquired using a fiber light spectrometer (Ocean Optics), with a flat Au 150 nm film deposited on a cleaned glass coverslip as a flat mirror reference. Hand-held Raman measurements were performed using a CBEx hand-held Raman spectrometer with 785 nm excitation, 50 mW power, and various acquisition times. Tabletop normal Raman measurements were performed using a 785 nm laser (Innovative Photonic Solutions); the Raman scattered light was collected and redispersed onto a LS785 spectrometer (Princeton Instruments) with a 600 groove/mm grating blazed at 750 nm. EC-SERS measurements were performed using an inverted microscope (Nikon Eclipse Ti-U), where the 785 nm laser excitation was focused onto the sample and the scattered light was collected using a 20× objective (Plan Fluor, NA=0.45, Nikon). The laser light was filtered using a 785 nm long pass filter (Semrock) and focused onto a ⅓ m spectrometer (SP2300, Princeton Instruments). The focused light was then dispersed (600 groove/mm grating, 1000 nm blaze) and focused onto a liquid nitrogen-cooled CCD detector (Spec10:400BR, Princeton Instruments). LSPR and Raman spectra were processed with OriginLab 8.0 and MATLAB.

Normal Raman Spectroscopy of Gentamicin.

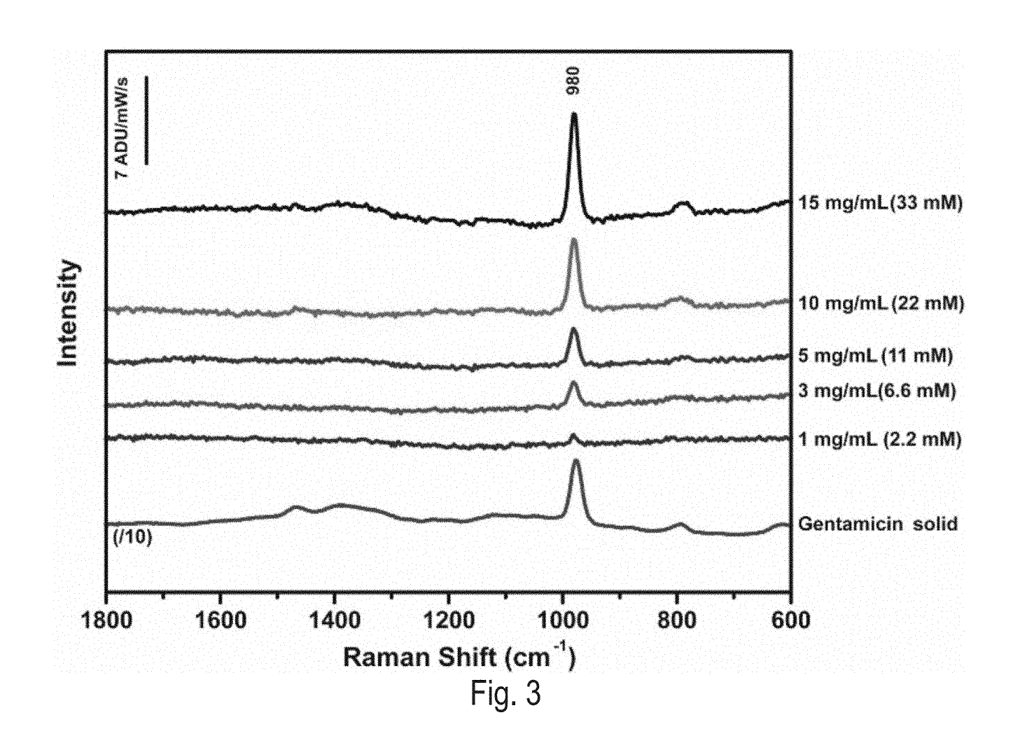

The primary model drug used for antibiotic detection and quantification via NRS in this work is gentamicin. Gentamicin is a heat-stable protein synthesis inhibitor used to treat Gramnegative and Staphylococcus bacterial infections and in orthopedic surgery. It is typically administered intravenously at 2 mg/mL (4.3 mM) and at pH 3.0-5.5.32 We analyzed the NRS spectra for nine reference gentamicin solutions ranging in concentration from 0.5 to 50 mg/mL (1.12-112 mM) using both a macro Raman instrumental setup and the CBEx handheld Raman spectrometer. Each data point presented is an average of five acquired spectra at an acquisition time of 5 s each. The most prominent spectral features of gentamicin were a major mode at 980 cm⁻¹ and a less intense mode at 790 cm⁻¹ (FIG. 3), which we tentatively assign to C—O—C stretching and C—H rocking modes, respectively. We then generated NRS linear profiles of concentration versus integrated signal intensity using the 980 and 790 cm⁻¹ modes. Prior to acquiring NRS spectra of gentamicin using the CBEx hand-held Raman spectrometer, we compared the spectral resolution of the CBEx to the macro Raman instrumental setup used. First, we acquired an NRS spectrum of cyclohexane, a Raman calibration standard, and compared the peak width of the 801.3 cm⁻¹ mode. The macro Raman setup had a peak full-width half-maximum (fwhm) of 12 cm⁻¹, and the CBEx had a peak fwhm of 18 cm⁻¹. Despite the 6 cm⁻¹ difference in fwhm, we found that the spectral quality of NRS spectra acquired using the CBEx is comparable to that of a standard macro Raman instrument.

The mean integrated peak intensities of the 980 and 790 cm⁻¹ modes versus concentration of gentamicin show an excellent linear relationship with R2 values of 0.997 and 0.994 for the standard Raman instrument and 0.999 and 0.999 for the CBEx hand-held Raman spectrometer, respectively. We found that the integrated peak area of each mode shows a similar linear dependence as a function of concentration with R2=0.996 and R2=0.986 for the standard macro Raman instrument and R2=0.999 and R2=0.992 for the CBEx handheld spectrometer, respectively. This strong linear trend with both the macro Raman setup and the CBEx handheld Raman spectrometer demonstrates the ability of NRS to sensitively and rapidly quantify antibiotic concentrations and the utility of hand-held Raman spectrometers for accurate quantitative Raman measurements.

We note that we detected Raman signal from lower concentrations of gentamicin at the clinically relevant concentration and partial signal below the clinical concentration in our prepared solutions. In order to verify the congruence of commercial gentamicin samples with our prepared solutions, we then analyzed solutions prepared from a 2 mg/mL commercial gentamicin IV bag solution received from Baxter Healthcare Corporation. This commercial gentamicin solution clearly demonstrated the mode at 980 cm⁻¹. The confirmed ability to detect NRS of gentamicin in a commercial solution within its clinical range shows promise for the use of hand-held Raman to identify antibiotics and other drugs in a clinical setting.

The linear dependence of Raman signal intensity acquired on a standard macro Raman setup versus gentamicin concentration exhibits an interval within 95% confidence of no greater than 0.131 ADU/mW/s aside from 0.234 ADU/mW/s at 50 mg/mL (Table 1). The clinically relevant concentrations tested on the macro Raman setup, 2 and 4 mg/mL, showed relatively small confidence intervals of 0.048 and 0.057 ADU/mW/s, respectively (Table 1). The corresponding experiment performed on the hand-held Raman CBEx device showed considerably increased precision. The linear dependence of Raman signal intensity acquired on the CBEx hand-held Raman device versus gentamicin concentration exhibits an interval within 95% confidence of no greater than 0.014 ADU/mW/s at any tested concentration aside from 50 mg/mL, which showed a relatively small confidence interval of 0.026 ADU/mW/s (Table 2). The concentrations tested within the clinically relevant regime, 2 and 4 mg/mL, showed particularly small confidence intervals of 0.009 and 0.010 ADU/mW/s, respectively (Table 2). We also note that each Raman measurement has an acquisition time of 5 s per 5 acquisitions, further demonstrating the rapid quantitative nature of handheld NRS experiments. This precise and well-defined relationship demonstrates the strength of this antibiotic's Raman spectrum as an accurate method to quantify drug concentrations both within and out of a clinically relevant concentration range using both a tabletop Raman setup and a hand-held Raman spectrometer.

TABLE 1

| | | Average | | 95% | 95% |
|---|---|---|---|---|---|
| | | integrated | | confidence | confidence |
| Concentration | Concentration | peak intensity | Standard | lower limit | upper limit |
| (mg/mL) | (mM) | (ADU/mW/s) | deviation | (ADU/mW/s) | (ADU/mW/s) |
| 0.5 | 1.05 | 0.477 | 0.05 | 0.456 | 0.499 |
| 2 | 4.2 | 1.55 | 0.06 | 1.52 | 1.57 |
| 4 | 8.4 | 2.79 | 0.07 | 2.76 | 2.81 |
| 6 | 12.6 | 4.51 | 0.07 | 4.48 | 4.54 |
| 8 | 16.8 | 5.01 | 0.1 | 4.97 | 5.05 |
| 12 | 25.1 | 8.44 | 0.1 | 8.4 | 8.48 |
| 20 | 41.9 | 14.3 | 0.1 | 14.3 | 14.4 |
| 25 | 52.4 | 17.8 | 0.2 | 17.8 | 17.9 |
| 50 | 105 | 34.7 | 0.3 | 34.6 | 34.8 |

TABLE 2

| | | Average | | 95% | 95% |
|---|---|---|---|---|---|
| | | integrated | | confidence | confidence |
| Concentration | Concentration | peak intensity | Standard | lower limit | upper limit |
| (mg/mL) | (mM) | (ADU/mW/s) | deviation | (ADU/mW/s) | (ADU/mW/s) |
| 2 | 4.2 | 0.358 | 0.009 | 0.354 | 0.362 |
| 4 | 8.4 | 0.715 | 0.008 | 0.71 | 0.721 |
| 6 | 12.6 | 1.1 | 0.009 | 1.1 | 1.11 |
| 8 | 16.8 | 1.46 | 0.01 | 1.46 | 1.47 |
| 12 | 25.1 | 2.22 | 0.02 | 2.21 | 2.22 |
| 20 | 41.9 | 3.49 | 0.01 | 3.49 | 3.5 |
| 25 | 52.4 | 4.48 | 0.02 | 4.48 | 4.49 |
| 50 | 105 | 9.01 | 0.03 | 9 | 9.02 |

In addition to quantification of gentamicin concentration with NRS, we examined the effect of pH on the Raman spectrum of gentamicin due to the possible variability of pH in the commercial IV bag solution. The commercial solution of 2 mg/mL gentamicin taken directly from the IV bag was pH=4.73. Solutions were prepared at ten pH levels ranging from 2 to 11, and after adjusting the peak intensity at 980 cm⁻¹ for the added volume of NaOH or HCl, we found the range of Raman signal intensity as a function of pH did not vary significantly. The minimal change in pH shows that gentamicin solutions can be quantified across a wide range of pH values. Overall, using a hand-held Raman instrument is an ideal means of rapidly quantifying drug concentrations in a clinical setting or for drug compounding.

Electrochemical SERS of Dobutamine.

In the case that the Raman signal is not detectable at clinically relevant concentrations, one can implement SERS to sufficiently amplify the Raman signal. The target analyte in this study was dobutamine, a drug used for improving blood flow and relieving symptoms of heart failure. It is most commonly administered intravenously in concentrations ranging from 0.5 to 4 mg/mL (1.5-12 mM) at pH 3.5-3.7. The most common commercial IV bag concentrations are 1, 2, and 4 mg/mL (3, 6, and 12 mM). Additional components of the commercial IV bag solution are 5% dextrose, edetate disodium dihydrate, and 1% sodium bisulfite. We were not able to detect dobutamine within the clinical range using NRS. We also found that dobutamine was not detectable by SERS using a bare, unfunctionalized AuFON due to weak binding of dobutamine to the AuFON surface.

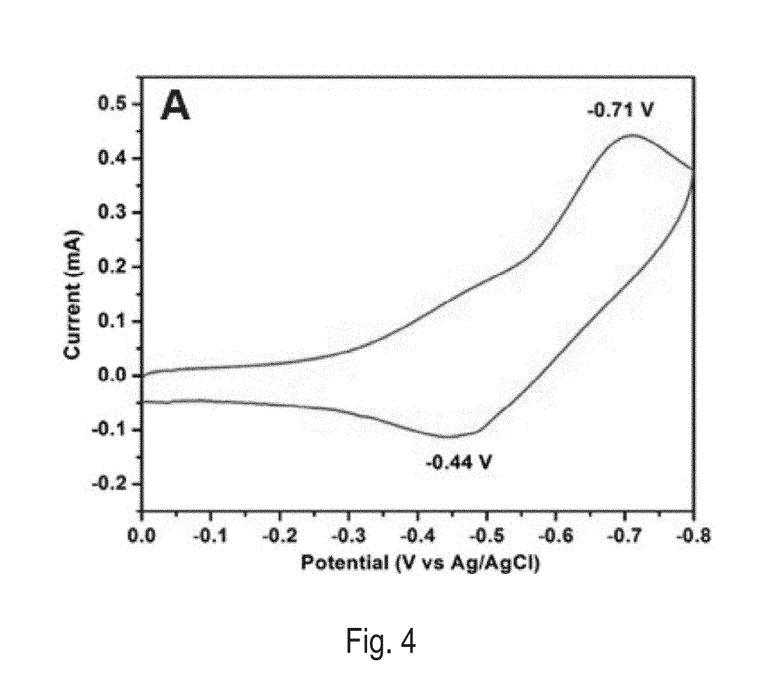

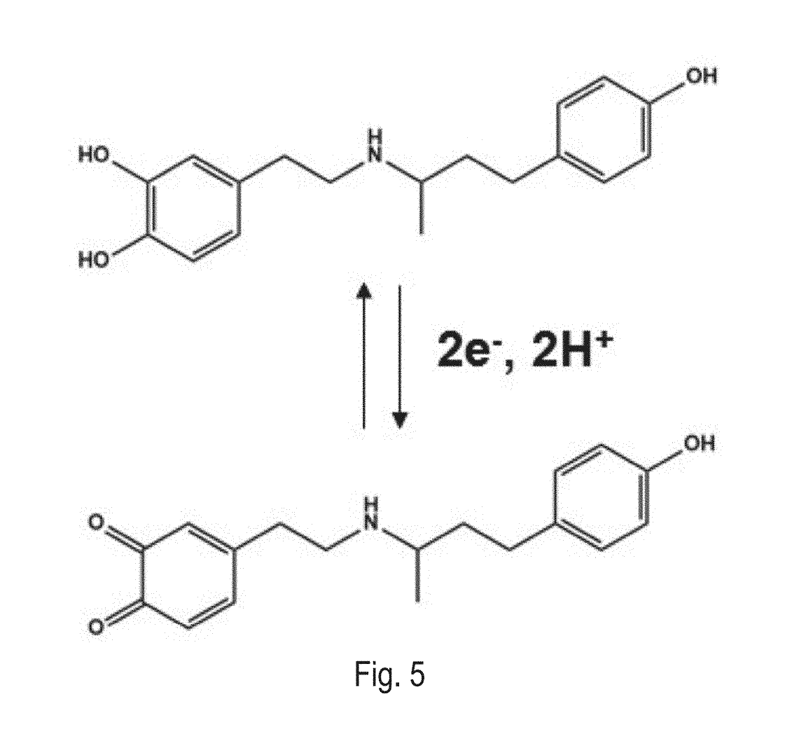

In order to reliably detect dobutamine with SERS, we chose to implement EC-SERS. First, we characterized the solution-phase electrochemistry of the dobutamine IV bag solution with an Au working electrode. The solution phase cyclic voltammogram (CV) using a polished Au disc working electrode is displayed in FIG. 4. Dobutamine is a catecholamine and undergoes a reversible 2-electron, 2-proton transfer to form its quinone species (FIG. 5).

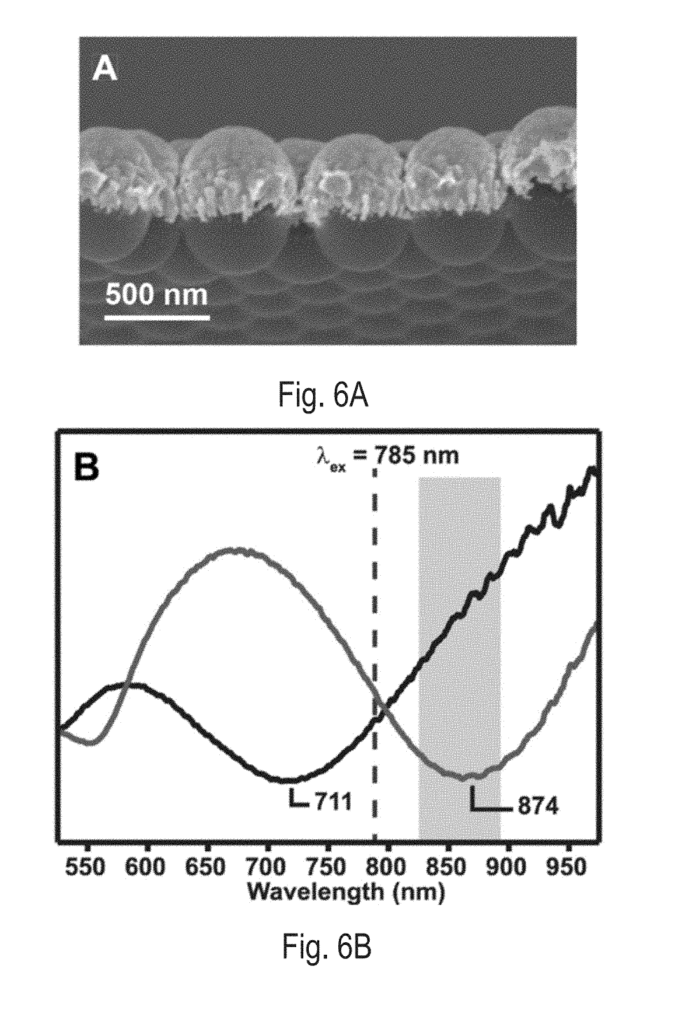

EC-SERS measurements were performed using an AuFON working electrode; an AuFON working electrode is a low-cost, highly enhancing SERS-active surface, and making electrical contact with the AuFON surface is trivial. The FON electrode was fabricated by drop casting 540 nm diameter SiO₂ microspheres on a cleaned 25 mm diameter Si wafer. After the spheres dried in a hexagonal close packed array on the surface, 150 nm Au was thermally deposited on the surface (FIG. 6A). The LSPR was measured in air and in the dobutamine solution, as the LSPR between a FON in air and in dobutamine solution changes due to the change in local refractive index at the SERS-active surface (FIG. 6B). The LSPR of the AuFON working electrode in dobutamine overlaps well with the 785 nm excitation wavelength (gray dashed line, FIG. 6B) and the wavelength region of the Raman scattered light (gray bar, FIG. 6B), ensuring optimal SERS enhancement.

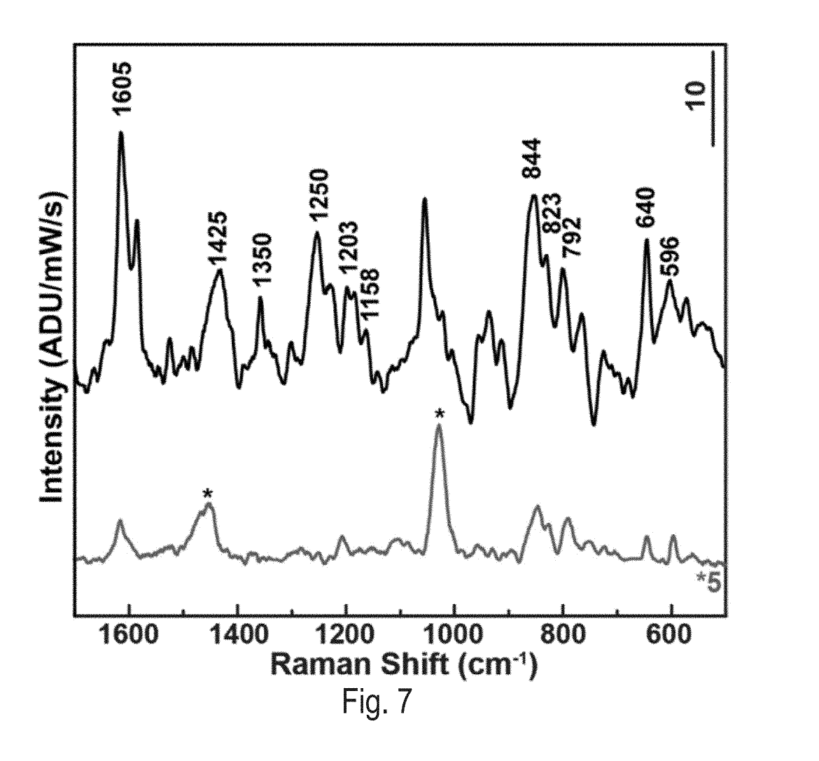

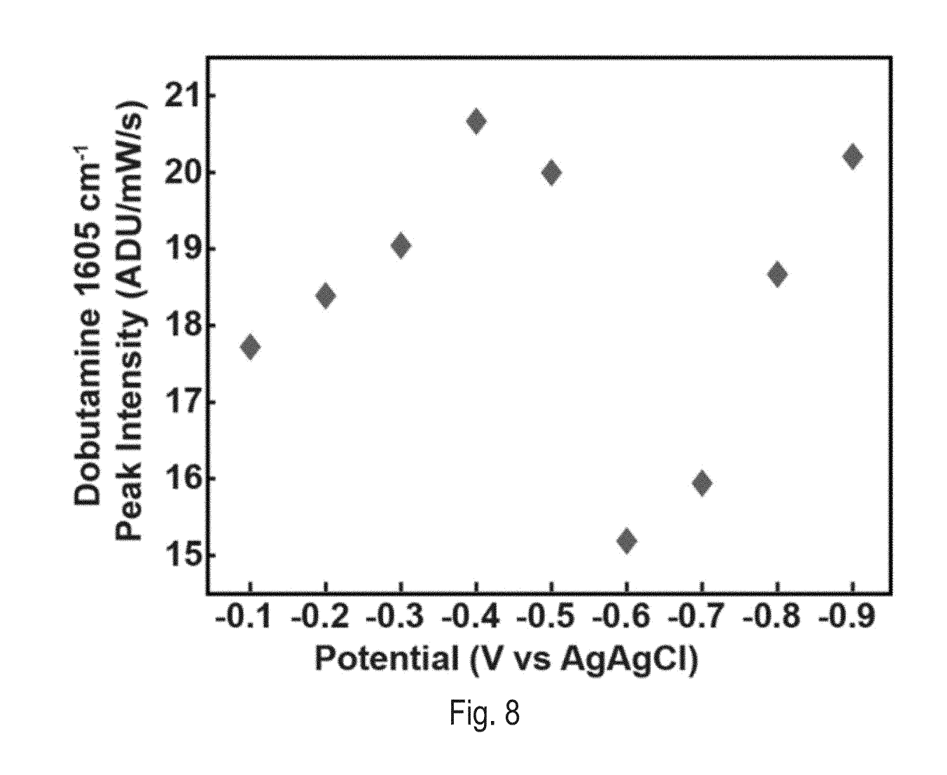

We first characterized the EC-SERS response of dobutamine: peaks at 596, 640, 792, 823, 1203, and 1605 cm⁻¹ are in excellent agreement with the dobutamine NRS spectrum. In particular, the peak at 1605 cm⁻¹ is assigned to the N-H vibration of the secondary amine. Additionally, there are peaks between 1100 and 1500 cm⁻¹ in FIG. 7 that do not appear in the solution phase dobutamine NRS spectrum; these modes are characteristic of a catechol moiety bound to Au. We then determined the optimal potential to apply to the AuFON working electrode to yield the strongest EC-SERS signal by applying potential stepwise from −0.1 to −0.9 V vs Ag/AgCl in 0.1 V intervals. As shown in FIG. 8, there is SERS signal at −0.1 V that increased to a maximum at −0.4 V (FIG. 8). As the applied potential is swept to more negative values, there is a signal intensity decrease beginning at −0.5 V and the SERS signal then increases in intensity at more negative potentials but does not surpass the intensity at −0.4 V. The decrease in signal between −0.5 and −0.8 V may be due to the oxidation of dobutamine to its quinone form and its relatively weak binding affinity for the AuFON working electrode surface. On the basis of these results, we chose to apply a constant potential of −0.4 V for detection of dobutamine for all of the following measurements in the study, unless otherwise noted. We also note that this is the first study to demonstrate EC-SERS of secondary catecholamines at acidic pH.

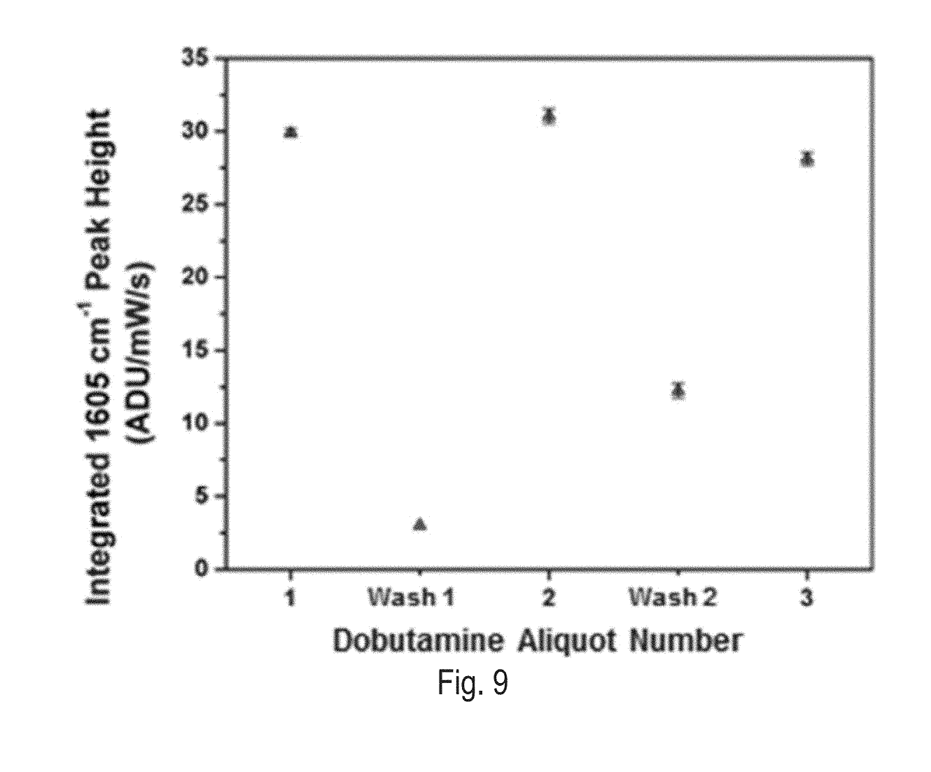

Precision and accuracy experiments were then performed to demonstrate the viability of using an AuFON working electrode as a sensing platform. Three separate aliquots of a 2 mg/mL commercial dobutamine IV bag solution were analyzed using the same AuFON working electrode; EC-SERS spectra were acquired from 5 random spots on the AuFON surface. Washing steps with MQ water were performed in between each aliquot measurement. The average peak intensities of the 1605 cm⁻¹ mode for each aliquot step are displayed in FIG. 9. The average peak intensity across the three washing steps does not decrease significantly, which demonstrates the stability and reusability of the AuFON working electrode for multiple EC-SERS measurements. However, the background signal after washing increased after the second wash step, indicating that some dobutamine may still be bound to the AuFON surface.

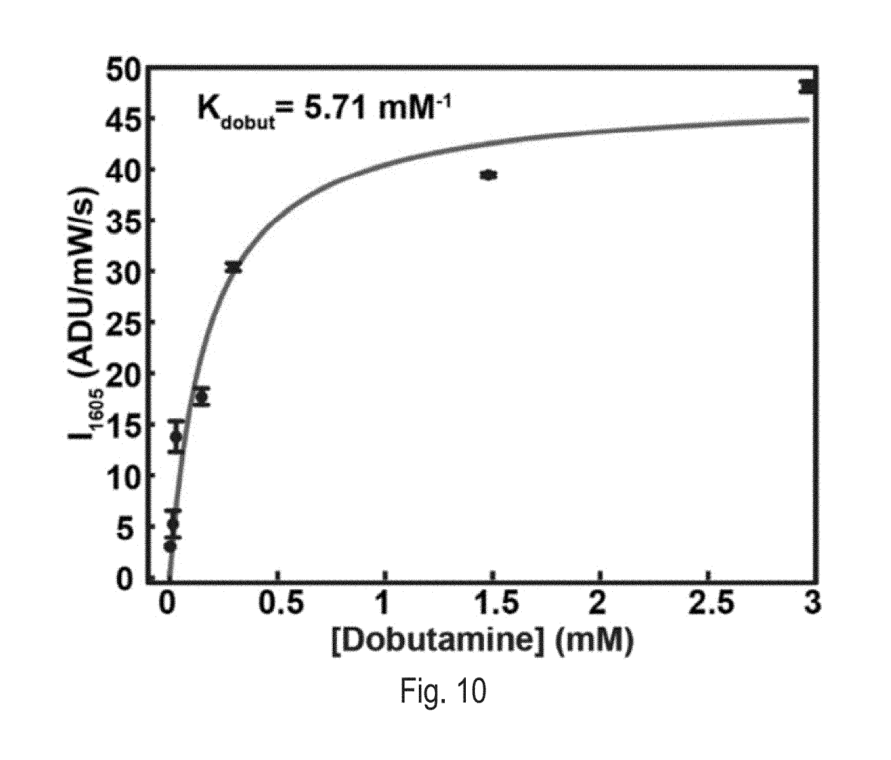

Lastly, we performed a limit of detection (LOD) study to determine the sensitivity of the EC-SERS technique. We prepared serial dilutions of the commercial dobutamine IV bag solution ranging from 100 ng/mL to 1 mg/mL (300 nM to 3 mM) and took SERS spectra with the potential held constant at −0.4 V (vs Ag/AgCl). Each data point in FIG. 10 is an average of 3-5 SERS spectra, where each spectrum is a different spot on the AuFON working electrode surface. We then used the integrated peak intensity of the 1605 cm⁻¹ peak to fit the EC-SERS data to a Langmuir adsorption isotherm:

$$\begin{matrix}θ = \frac{{I}_{1605}}{{I}_{1605 , max}} = \frac{{K}_{dobut} [ D ]}{1 + {K}_{dobut} [ D ]} & ( 1 ) \\ \frac{1}{{I}_{1604}} = \frac{1}{{K}_{dobut} {I}_{1604}} \frac{1}{[ D ]} + \frac{1}{{I}_{1604 , max}} & ( 2 )\end{matrix}$$

where θ is the fractional surface coverage, I₁₆₀₅ is the normalized peak intensity at 1605 cm⁻¹, [D] is the dobutamine concentration in mM, and Kdobut is the binding constant. We determined the Kdobut from the Langmuir isotherm fitted data to be 5.7 mM⁻¹ (FIG. 10). We then determined the limit of detection for dobutamine, which is defined as the peak intensity being 3 times greater than the noise level; the LOD of dobutamine was found to be 3×10⁻⁷M, which is 4 orders of magnitude below the clinical concentration range and agrees well with previous LOD studies of catecholamines with EC-SERS. This data demonstrates that EC-SERS is an extremely sensitive technique for the label-free detection of clinically relevant drugs that cannot be detected using NRS or that bind weakly to SERS substrates.

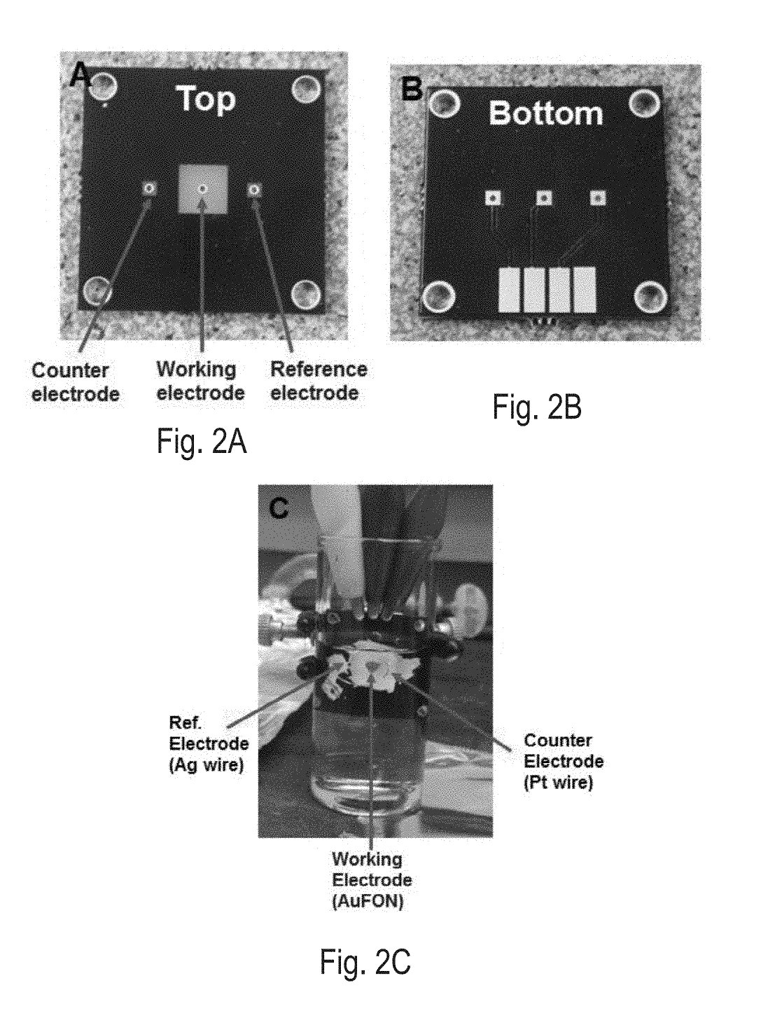

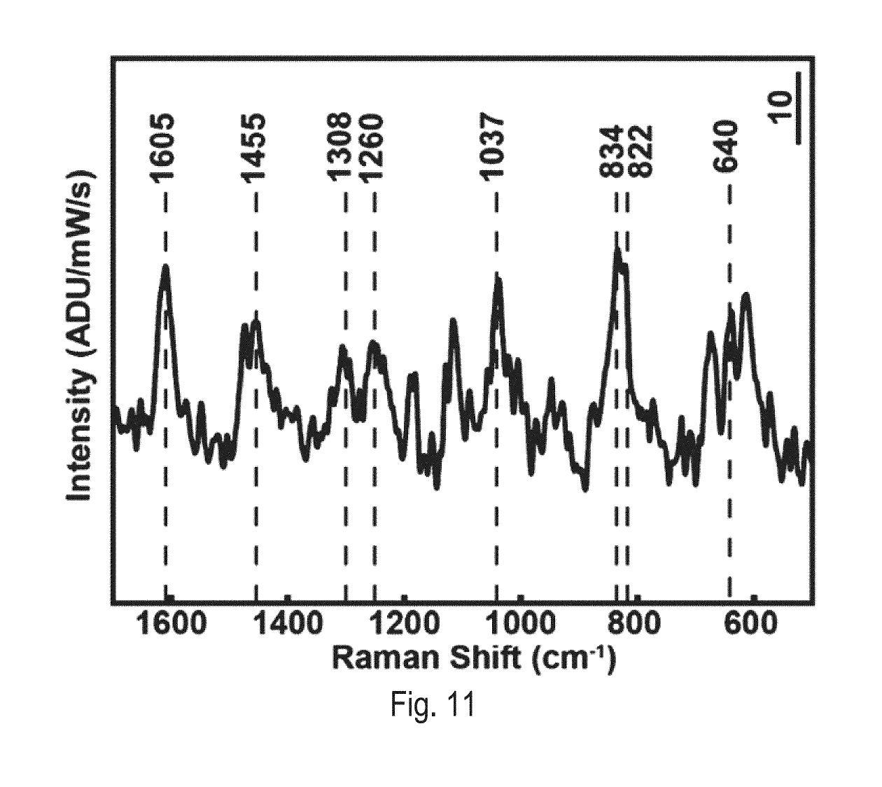

Lastly, we have demonstrated the feasibility of EC-SERS detection of dobutamine in a clinical setting by designing a low cost, disposable EC-SERS device that can be used for either inline or off-line testing. A photograph of the bare chip and the assembled EC-SERS device is shown in FIGS. 2A, 2B, and 2C. Each disposable EC-SERS device is anticipated to cost approximately $3 and can be fabricated to be less than ˜1 in2 using standard printed circuit board. We used the EC-SERS chip to successfully detect dobutamine taken from a commercial 4 mg/mL IV solution, using the CBEx hand-held Raman spectrometer (FIG. 11). The successful detection of dobutamine with a portable chip and hand-held Raman spectrometer proves that EC-SERS has the potential to be a low-cost, sensitive sensing technique for detection of clinically relevant analytes.

Either NRS or EC-SERS can be used as a rapid and sensitive tool to monitor drug concentrations in a clinical setting or for drug compounding. First, we demonstrate the successful detection and precise quantification of gentamicin within its clinically relevant range using both a standard macro and handheld Raman instrument. In the case that the analyte cannot be detected within its clinically relevant range with NRS, like in the case of dobutamine, we can implement SERS. In particular, we implement a label-free EC-SERS detection approach due to the otherwise weak binding of dobutamine on an AuFON SERS substrate. We demonstrate that EC-SERS can detect dobutamine at clinically relevant concentrations and pH range with an LOD of 100 ng/mL (300 nM) and with good accuracy and precision. Additionally, this is the first study to demonstrate EC-SERS of secondary amines at acidic pH. We also demonstrate the potential for a low-cost, commercially viable SERS-active chip for performing EC-SERS experiments in a clinical setting. Overall, this work demonstrates that Raman-based methodologies are a powerful means of facile, rapid monitoring of drug concentrations in a clinical setting or for drug compounding applications.

Although the invention has been described in considerable detail with reference to certain aspects, one skilled in the art will appreciate that the present invention can be practiced by other than the described embodiments, which have been presented for purposes of illustration and not of limitation. Therefore, the scope of the appended claims should not be limited to the description of the embodiments contained herein.

We claim:

1. A system for identifying and measuring concentration of a drug of interest in an intravenous drug solution, the system comprising:
a sample chamber configured to receive the intravenous drug solution;
an electrochemical surface enhanced Raman (EC-SERS) substrate positioned in the sample chamber in a first location where the intravenous drug solution contacts the EC-SERS substrate when introduced into the sample chamber;
a counter electrode positioned in the sample chamber in a second location where the intravenous drug solution contacts the counter electrode when introduced into the sample chamber, the counter electrode separated from the EC-SERS substrate by a first predetermined distance;
a power supply coupled to the EC-SERS substrate and the counter electrode;
a Raman spectrometer; and
a computer including a processor and a memory, the processor in electronic communication with the power supply and the Raman spectrometer, the memory having stored thereon a reference spectrum for the drug of interest in the intravenous drug solution,
the power supply configured to apply a voltage to the EC-SERS substrate,
the Raman spectrometer configured relative to the EC-SERS substrate to acquire a Raman spectrum of the intravenous drug solution when the intravenous drug solution is contacting the EC-SERS substrate,
the memory having further stored thereon instructions that, when executed by the processor, cause the processor to control the power supply and Raman spectrometer to acquire an EC-SERS spectrum of the intravenous drug solution in the sample chamber.

2. The system of claim 1, wherein the EC-SERS substrate is a film over nanosphere substrate.

3. The system of claim 2, wherein the film over nanosphere substrate comprises SiO₂ microspheres coated with a gold layer.

4. The system of claim 1, wherein the EC-SERS substrate and the counter electrode are positioned on a single chip.

5. The system of claim 1, the system further comprising a reference electrode positioned in the sample chamber in a third location where the intravenous drug solution contacts the reference electrode when introduced into the sample chamber, the reference electrode separated from the EC-SERS substrate by a second predetermined distance and from the counter electrode by a third predetermined distance.

6. The system of claim 5, wherein the reference electrode is an Ag/AgCl reference electrode.

7. The system of claim 5, wherein the EC-SERS substrate, the counter electrode, and the reference electrode are all positioned on a single chip.

8. The system of claim 1, wherein the counter electrode is a Pt counter electrode.

9. The system of claim 1, the system further comprising one or more lenses or microscope objectives configured to couple light from the Raman spectrometer to the EC-SERS substrate.

10. The system of claim 1, wherein the sample chamber comprises an inlet.

11. The system of claim 10, wherein the inlet is coupled to an intravenous bag via tubing, the intravenous bag containing the intravenous drug solution.

12. The system of claim 1, wherein the Raman spectrometer is a handheld Raman spectrometer.

13. A method comprising:
acquiring an electrochemical surface enhanced Raman (EC-SERS) spectrum of an intravenous drug solution, the intravenous drug solution suspected of containing a drug of interest in a desired concentration, the acquired EC-SERS spectrum having peak locations and peak intensities;
comparing the acquired EC-SERS spectrum to a reference EC-SERS spectrum for the drug of interest in the desired concentration, the reference EC-SERS spectrum having reference peak locations and reference peak intensities;
if the peak locations match the reference peak locations within a first predefined error value, then confirming that the intravenous drug solution contains the drug of interest; and
if the peak intensities match the reference peak intensities within a second predefined error value, then confirming that the intravenous drug solution contains the drug of interest in the desired concentration.

14. The method of claim 13, wherein the EC-SERS spectrum is acquired using a film over nano sphere substrate EC-SERS substrate.

15. The method of claim 14, wherein the film over nanosphere substrate comprises SiO₂ microspheres coated with a gold layer.

16. A kit comprising:
an electrochemical surface enhanced Raman (EC-SERS) chip comprising an EC-SERS substrate and a counter electrode separated by a first predetermined distance; and
a memory having stored thereon a reference EC-SERS spectrum for identifying and determining a concentration of a drug of interest in an intravenous drug solution by acquiring an EC-SERS spectrum of the intravenous drug solution using the EC-SERS chip.

17. The kit of claim 16, wherein the EC-SERS substrate is a film over nanosphere substrate.

18. The kit of claim 17, wherein the film over nanosphere substrate comprises SiO₂ microspheres coated with a gold layer.

19. The kit of claim 16, the EC-SERS chip further comprising a reference electrode, the reference electrode separated from the EC-SERS substrate by a second predetermined distance and from the counter electrode by a third predetermined distance, and wherein the reference electrode is an Ag/AgCl reference electrode.

20. The kit of claim 16, wherein the counter electrode is a Pt counter electrode.
